(19) United States
(12) Patent Application Publication
(10) Pub. No.: US 2019/0354884 A1
(43) Pub. Date: Nov. 21, 2019

(54) KNOWLEDGE CONSTRUCTION AND UTILIZATION SYSTEM AND PROGRAM

(71) Applicants: KABUSHIKI KAISHA TOSHIBA, Minato-ku (JP); TOSHIBA DIGITAL SOLUTIONS CORPORATION, Kawasaki-shi (JP)

(72) Inventor: Tetsuro CHINO, Kawasaki (JP)

(73) Assignees: KABUSHIKI KAISHA TOSHIBA, Minato-ku (JP); TOSHIBA DIGITAL SOLUTIONS CORPORATION, Kawasaki-shi (JP)

(21) Appl. No.: 16/463,475

(22) PCT Filed: Nov. 22, 2017
(86) PCT No.: PCT/JP2017/042016

§ 371 Date: May 23, 2019

(30) Foreign Application Priority Data
Nov. 25, 2016 (JP) 2016-229306

(51) Int. Cl. G06N 5/04; G06F 16/36; G06F 16/958; G06Q 50/10; G06F 3/0484

(52) U.S. Cl. CPC G06N 5/04; G06F 16/36; G06F 3/04842; G06Q 50/10; G06F 16/958

(57) ABSTRACT

A knowledge construction and utilization system includes a plurality of user terminals and a server. Each of the user terminals includes an input mechanism for inputting a first knowledge information piece, a communication mechanism for transmitting and receiving the first knowledge information piece to and from the server, and an output mechanism for outputting a received knowledge information piece. The server receives the first knowledge information piece input from one of the user terminals, analyzes a topic and a speech function of the first knowledge information piece, extracts one or more of the knowledge information pieces having a correspondence to the first knowledge information piece based on the result in the analysis, and notifies other user terminals than the user terminal which transmitted the first knowledge information piece of the fact that the one or more knowledge information pieces are transmitted to the user terminal.

### TECHNICAL FIELD

An embodiment of the present invention relates to a knowledge construction and utilization system and program.

### BACKGROUND ART

There have conventionally been systems for facilitating information sharing between users to construct and utilize knowledge by helping a user having a question in asking preceding users for advice. Some systems record previously input questions in association with answers input in response to those questions, and upon input of a new question by a user, search the records for the same or similar previous question, acquire the previous answer to the question, and present the acquired answer to the user. However, such systems have a problem in which an answer may not be obtained since a user having expertise in a question from another user cannot immediately answer the question. In addition, such systems have a problem of not ensuring that a previous answer obtained from the records is appropriate as an answer to a newly input question.

### PRIOR ART DOCUMENTS

### Patent Documents

[Patent Document 1] Japanese Patent Laid-Open No. 2004-118739

[Patent Document 2] Japanese Patent No. 3455790

[Patent Document 3] Japanese Patent Laid-Open No. 1996-255150

### DISCLOSURE OF THE INVENTION

### Problems to be Solved by the Invention

It is an object of the present invention to provide a knowledge construction and utilization system and program capable of presenting an answer to a question of a user in real time and achieving improved reliability of the answer presented to the user.

### Means for Solving the Problems

To achieve the object, a knowledge construction and utilization system according to an embodiment includes a plurality of user terminals and a server. Each of the user terminals includes input means for inputting a first knowledge information piece, communication means for transmitting and receiving the first knowledge information piece to and from the server, and output means for outputting a knowledge information piece received from the server. The server includes reception means for receiving the first knowledge information piece input from one of the user terminals, analysis means for analyzing a topic and a speech function of the first knowledge information piece, storage means for saving knowledge information pieces and a correspondence between the knowledge information pieces, correspondence extraction means for extracting one or more of the knowledge information pieces having a correspondence to the first knowledge information piece from the storage means based on the result in the analysis means, transmission means for transmitting the extracted one or more knowledge information pieces to the one of the user terminal, and notification means for notifying the other user terminals than the user terminal which transmitted the first knowledge information piece of the fact that the one or more knowledge information pieces are transmitted to the user terminal.

### BRIEF DESCRIPTION OF THE DRAWINGS

FIG. 1 A functional block diagram showing the overall configuration of a knowledge construction and utilization system according to the present embodiment.

FIG. 2 A sequence diagram showing a flow of operation performed when an answer to a question message is not saved in the knowledge construction and utilization system according to the present embodiment.

FIG. 3 A sequence diagram showing a flow of operation performed when a message possibly serving as an answer is already stored in the knowledge construction and utilization system according to the present embodiment.

FIG. 4 A sequence diagram showing a flow of input of a complementary message and the like in the knowledge construction and utilization system according to the present embodiment.

FIG. 5 A diagram showing a flow for voice message registration in the knowledge construction and utilization system according to the present embodiment.

FIG. 6 A diagram showing a flow for reply message transmission in the knowledge construction and utilization system according to the present embodiment.

FIG. 7 A diagram showing a flow for check request message transmission in the knowledge construction and utilization system according to the present embodiment.

FIG. 8 A diagram showing an example of information stored in a user information storage section of the knowledge construction and utilization system according to the present embodiment.

FIG. 9 A diagram showing an example of information stored in a correspondence storage section of the knowledge construction and utilization system according to the present embodiment.

FIG. 10 A diagram showing an example of information stored in a speech language message storage section of the knowledge construction and utilization system according to the present embodiment.

FIG. 11 A diagram showing an example of information stored in a constructed knowledge storage section of the knowledge construction and utilization system according to the present embodiment.

FIG. 12 A diagram showing an example of information stored in a creation template storage section of the knowledge construction and utilization system according to the present embodiment.

FIG. 13 A sequence diagram relating to contribution analysis and useful knowledge introduction in the knowledge construction and utilization system according to the present embodiment.

### MODE FOR CARRYING OUT THE INVENTION

Embodiments for carrying out the present invention will be described in the following with reference to the accompanying drawings.

<Configuration and Simple Connection Relationship>

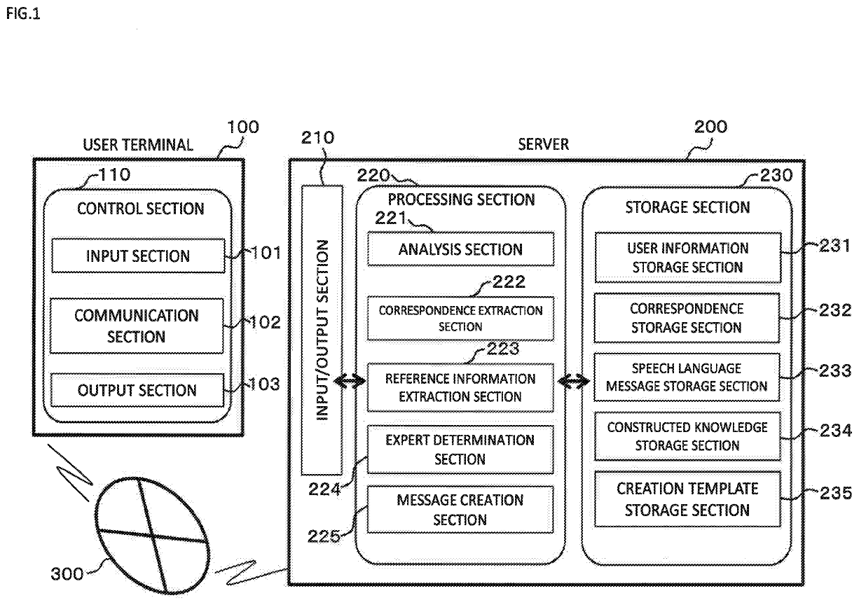

FIG. 1 is a functional block diagram showing the overall configuration of a knowledge construction and utilization system according to Embodiment 1 of the present invention. As shown in FIG. 1, the knowledge construction and utilization system is configured to connect a user terminal 100 (client terminal) to a server 200 through a network 300. The server 200 receives voice message data input from the user terminal 100, records the contents of the voice message, extracts and records a speech function and a topic of the voice message. The speech function means the speech intention of a user who issued the voice message such as “question,” “answer,” “request,” “acceptance,” and “reject.”

The user terminal 100 is, for example, a smartphone, a tablet, and a PC, and has a control section 110. The control section 110 includes an input section 101, a communication section 102, and an output section 103. The input section 101 acquires voice message data. The output section 103 outputs the result transmitted from the server 200. The communication section 102 transmits and receives voice message data between the user terminal 100 and the server 200. The functions of the respective sections of the control section 110 are performed by a microprocessor, not shown, implemented in the user terminal 100 executing a user terminal application program. However, these functions may be performed by hardware.

The server 200 includes an input/output section 210, a processing section 220, and a storage section 230. The input/output section 210 transmits and receives a voice message to and from the user terminal 100. The processing section 220 includes an analysis section 221, a correspondence extraction section 222, a reference information extraction section 223, an expert determination section 224, and a message creation section 225. The functions of the respective sections of the processing section 220 are performed by a microprocessor, not shown, implemented in the server 200 executing a program. However, these functions may be performed by hardware.

The analysis section 221 analyzes a voice message input from the user terminal 100, identifies the speech function of the message, and extracts the topic. The topic is a keyword which represents the contents of the message. The correspondence extraction section 222 extracts a stored voice message which can be paired with the input voice message. The reference information extraction section 223 refers to topics stored in a constructed knowledge storage section 234 to extract reference information which most matches the topic of the voice message registered in a speech language message storage section 223. A user information storage section 231 stores information about topics in which users have expertise, and based on this information, the expert determination section 224 searches for a user having expertise in the topic extracted from the voice message. The message creation section 225 refers to the speech language message storage section 233 and a creation template storage section 235 to create a voice message to be presented to the user.

The storage section 230 includes the user information storage section 231, a correspondence storage section 232, the speech language message storage section 233, the constructed knowledge storage section 234, and the creation template storage section 235. The user information storage section 231 stores the IDs of system users and words (keywords) relating to things in which the users have expertise. The correspondence storage section 232 stores the message IDs of voice messages having correspondence extracted by the correspondence extraction section 222 in the order of appearance. The speech language message storage section 233 saves the contents of input voice messages, message IDs assigned to the voice messages, IDs of users who issued the messages, extracted speech functions, topics, knowledge IDs in the constructed knowledge storage section 234 for reference in making a reply, and destination user IDs specified by the expert determination section 224. The constructed knowledge storage section 234 stores sets of voice messages together with their knowledge IDs, the voice messages of each set being associated with each other based on the topic extracted by the analysis section 221. The creation template storage section 235 stores introduction messages, templates and the like for use in requesting a message of a user or in reproducing the contents of a voice message.

In the illustrated example, n users carry their user terminals having a voice input/output function and perform wireless communication with the respective terminals to use the system. Alternatively, the system may be implemented in a configuration including any number of user terminals having only one of input means and output means. The system may be implemented in combination with wired communication. It is also possible to use a user terminal capable of input through a GUI (Graphical User Interface), physical button, physical dial, or touch operation. Knowledge information in the embodiment refers to a message input by a user or a message created by the system. While the knowledge information is input through a voice signal in the embodiment, the knowledge information may be implemented with text, image, or moving image other than the voice signal, or with a combination of more than one of them.

<Overview of Operation>

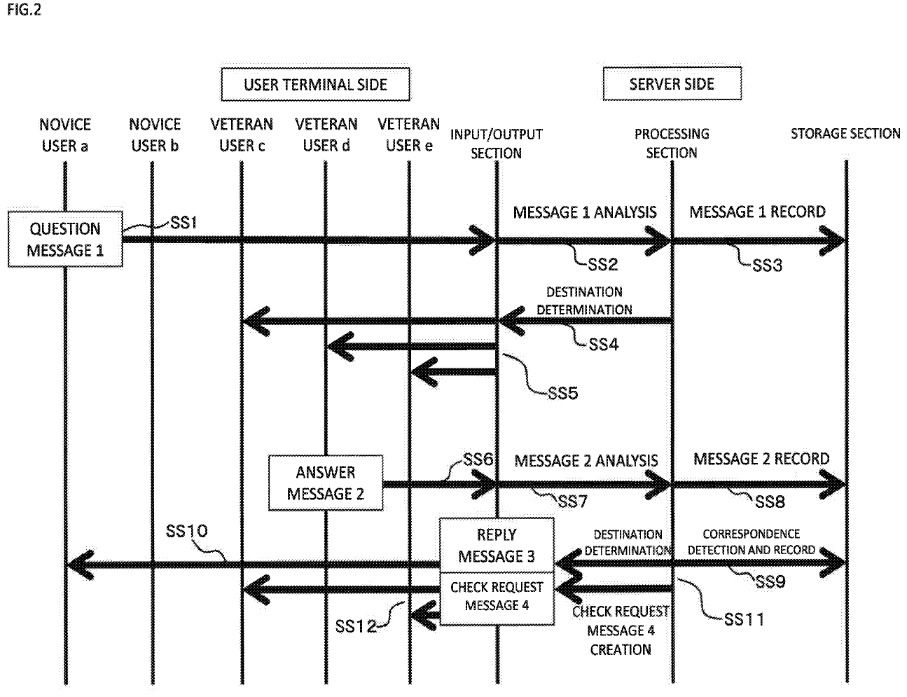

Next, the overview of the operation of the system is described with reference to sequence diagrams of FIG. 2 to FIG. 4. In the example, the system is used by five users including a novice users a, b, and veteran users c, d, and e. The novice users a, b are beginners who do not have expertise in topics being treated in this example, whereas the veteran users c, d, and e are experts having expertise.

FIG. 2 is a sequence diagram showing a flow of operation performed when an answer to a question message is not saved in the system. First, when the novice user a inputs a question message 1 (SS1), the message 1 is transmitted to the server, and the contents of the question message 1 are analyzed (SS2) and stored (SS3). When any voice message of similar contents having correspondence to the contents of the question message 1 is not stored, the veteran users c, d, and 3 are determined as destinations in view of the contents of the question message 1 (SS4), and the question message 1 from the novice user a is transmitted to the veteran users c, d, and e (SS5).

Next, when an answer message 2 to the question message 1 is input from the veteran user d (SS6), the contents of the answer message 2 are analyzed (SS7) and stored (SS8).

Subsequently, the question message 1 from the user a and the answer message 2 from the user d are stored as a correspondence (SS9), and simultaneously, the answer message 2 from the user d is transmitted as a reply message 3 to the novice user a (SS10). To check whether the answer message 2 from the user d is proper as the reply message 3 and whether any complementary information or the like is present, a check request message 4 is created, and the veteran users c, e are determined as its destinations (S11). Then, the check request message 4 is transmitted to the veteran users c, e (SS12).

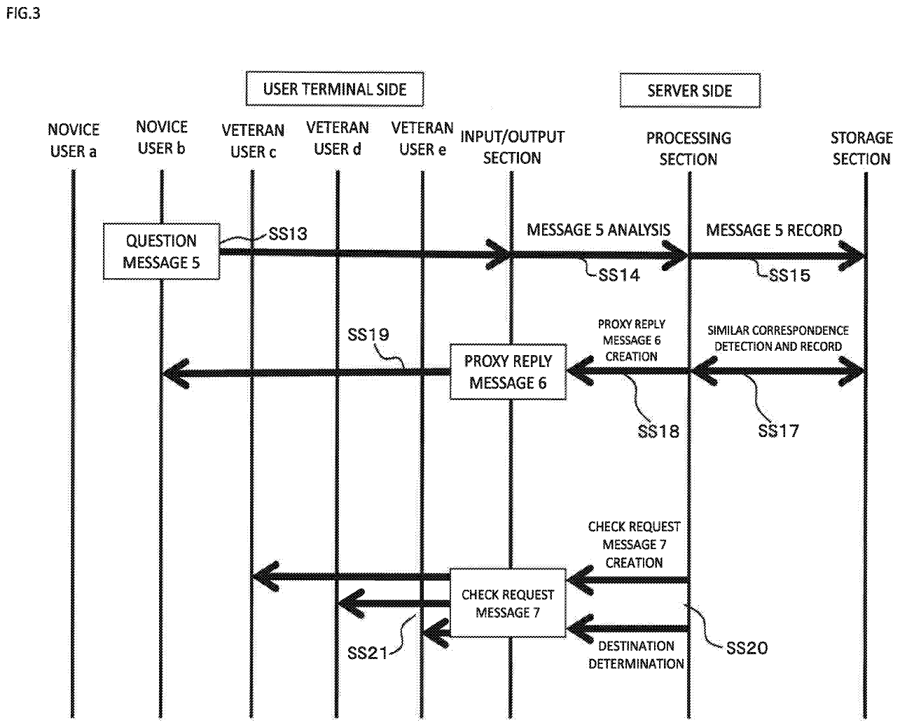

Next, a flow of operation performed when a voice message possibly serving as a reply message is already stored is described with reference to a sequence diagram of FIG. 3. When the novice user b inputs a question message 5 (SS13), the message 5 is transmitted to the server, and the contents of the question message 5 are analyzed (SS14) and stored (SS15). When any voice message of similar contents having correspondence to the contents of the question message 5, that is, any voice message possibly serving as a reply message, is present (SS17), the system automatically creates a proxy reply message 6 based on the voice message having correspondence (SS18) and transmits the created message 6 to the novice user b (S19). To check whether the created proxy reply message 6 is proper as the answer and whether any complementary information or the like is present, a check request message 7 is created (SS21). The veteran users c, d, and e are determined as its destinations (SS20), and the check request message 7 is transmitted thereto.

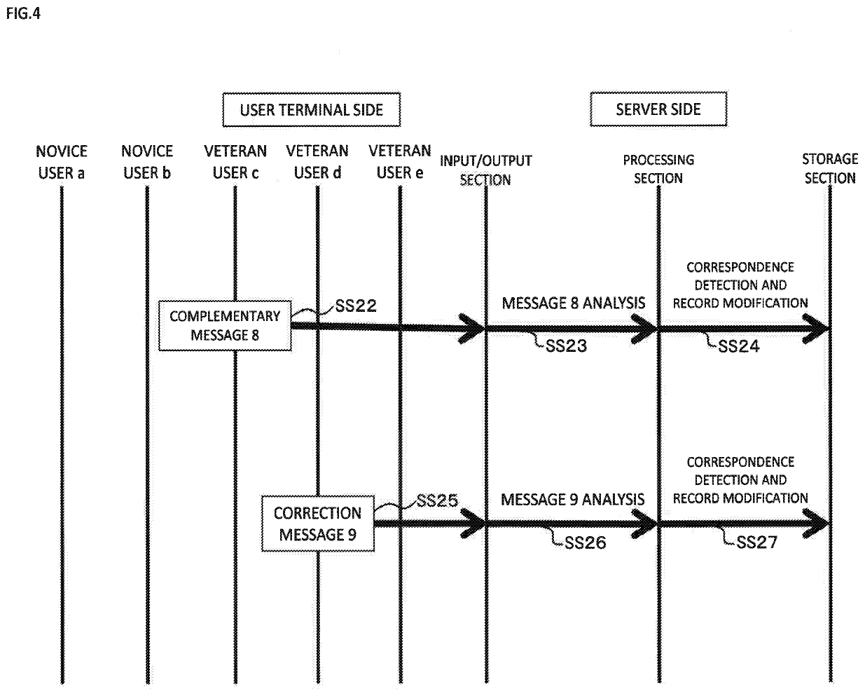

FIG. 4 is a sequence diagram showing a flow of input of a complementary message and the like in the system. When the veteran c inputs a complementary message 8 including complementary information (SS22) and the veteran d inputs a correction message 9 including correction information (SS25) in response to the check request message 7, the contents of each of the messages are analyzed (SS23, SS26) and stored (SS24, SS27) in association with the voice message of the contents to be paired with, after correction of stored knowledge as appropriate.

As described above, to check whether the message transmitted to the novice user who inputted the question message is proper as the answer and whether any complementary information or the like is present, the answer transmitted by one of the veteran users is also transmitted to the other veteran users and the created proxy reply message is also transmitted to the veteran users. When one of the veteran users inputs a voice message for complement to the contents of the answer or the proxy reply message, that voice message is also analyzed and stored. This mechanism allows the messages to be stored with their contents checked repeatedly, so that the system can present a reliable proxy reply message.

<Detailed Operation Description>

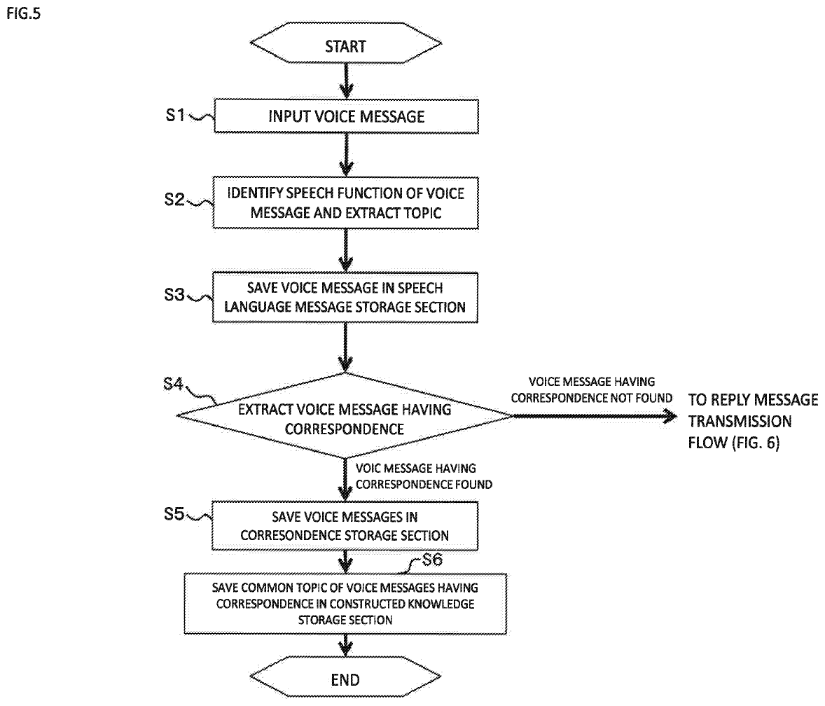

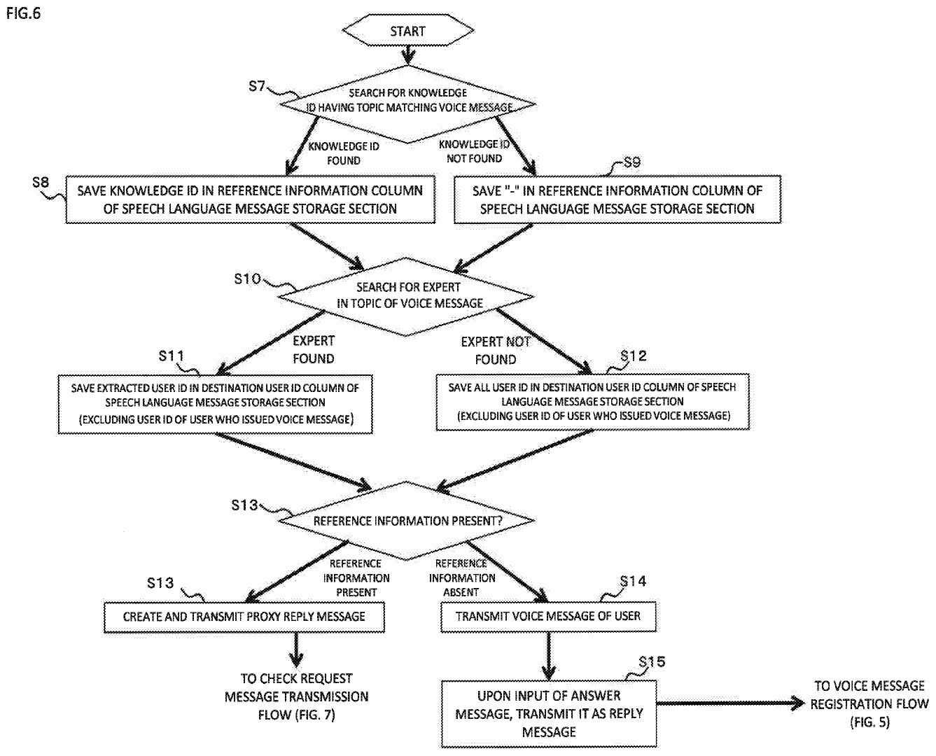

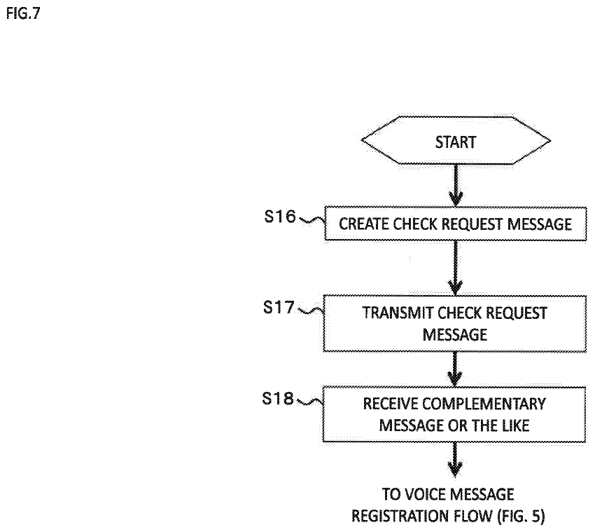

Next, a flow for voice message registration in the system according to the embodiment is described with reference to FIG. 5. First, a voice message is acquired with a microphone mounted on the user terminal 100 and is transmitted to the server 200 through the output section 103 (S1). The acquired voice message is transmitted together with user identification information. The user identification information corresponds to a user ID used when a user logs in to the system on the user terminal, for example.

Subsequently, the voice message transmitted from the user terminal 100 is transmitted to the analysis section 221 through the input/output section 210 of the server 200. The analysis section 221 analyzes the voice message input from the input/output section 210, determines the speech function of the voice message, and extracts the topic (S2). The analysis involves voice analysis processing including voice activity detection and spectrum analysis of the voice message to create text data. The text data is subjected to morphological analysis to recognize words which are compared with a prepared voice recognition vocabulary dictionary to find any match between them. The analysis processing is performed by using a known voice signal detection, recognition, and analysis technique. The analysis also involves referring to the length and the volume of the detected voice, the presence or absence of a particular phrase, the part of speech of each word included in the voice message and the number of appearances thereof, determining the speech function of the voice message using a known technique, and extracting the topic.

The extraction processing of the speech function and topic can be performed by using a known technique. For example, the recognized character string (text data) of the speech language message may be subjected to the morphological analysis, and matching processing may be performed between information about utterance-unit tags given to a speech language corpus and corresponding surface strings to determine the speech function included in each voice message. In addition, to allow more efficient processing, information to be used may be arranged in table form, or search may be performed by taking account of orthographical variants or inflection due to conjugation, thereby achieving the speech function determination from the voice message.

Next, the voice message is assigned a message ID and is saved in the speech language message storage section 233 together with the user ID, the extracted speech function, and the extracted topic (S3). This example assumes that the user corresponds to the novice user in the sequence diagrams of FIG. 2 to FIG. 4 and that the user inputs the message having the speech function of question.

Next, the correspondence extraction section 222 refers to the speech language message storage section 233 to search for any voice message to be paired with the input voice message (S4). The correspondence extraction section 222 extracts any voice message having a correspondence to the input voice message. When no voice message having a correspondence can be extracted, the control proceeds to a flow for reply message transmission (described later). The correspondence between the speech languages means an interrelation between speech intentions called “utterance pair (relationship),” for example “answer” to “question,” or “acceptance” or “rejection” to “request.” The “utterance pair” is an information structure corresponding to “an adjacency pair” in conversation analysis or “an exchange” in conversation analysis. The correspondence of the utterance pair can be extracted with a known method based on comparison with a table in which combinations of possibly paired utterance functions are previously stored, the presence or absence of matching topics, association between topics, a hierarchical relationship and the like. When a plurality of voice messages having a correspondence to the input voice message are present, the degree of association between topics is considered or a yet-unpaired voice message is used preferentially to store the correspondence. The extracted pair of voice messages are assigned pair relationship IDs and are stored in the correspondence storage section 232 together with their message IDs (S5).

Subsequently, the topic column in the speech language message storage section 233 is referred to, and the common topic of the voice messages paired by the correspondence extraction section 222 is saved in the constructed knowledge storage section 234 (S6). The common topic is assigned a knowledge ID and is saved in the constructed knowledge storage section 234 together with their message IDs.

Next, a flow for reply message transmission in the system according to the embodiment is described with reference to FIG. 6. First, the reference information extraction section 223 refers to the constructed knowledge storage section 234 to search for any knowledge ID having a registered topic which matches the topic of the voice message saved in the speech language message storage section 233 (S7). When a knowledge ID having a matching topic is present, the knowledge ID is stored in the reference information column of the speech language message storage section 233 (S8). When no knowledge ID having any matching topic is present, “-” is stored in the reference information column (S9). As a method of determining the presence or absence of the ID having a matching topic, it may be determined that no knowledge ID having any matching topic is present when all knowledge IDs have topics each including a predetermined number or less of matching words, and it may be determined that a knowledge ID having a matching topic is present when the knowledge ID has a topic including a predetermined number or more of matching words. Another method of determination including considering a semantic distance may be used, or the determination may be performed by using those methods in combination. When a plurality of knowledge IDs having a matching topic are present, all of them may be stored, a predetermined number or less of them may be selected and stored, or one of those knowledge IDs that has the most matching topic may be stored. Most matching means the largest number of matching words registered as the topic. Another method including calculating a semantic distance of words registered as the topic may be used, or the determination may be performed by using those methods in combination.

Next, a user to whom a reply message should be transmitted is searched for (S10). The expert determination section 224 refers to the user information storage section 231 to extract a user ID having expertise which matches the topic extracted from the voice message of the user. The user (hereinafter referred to as an expert) having the matching expertise corresponds to the veteran user in the previous sequence diagrams. As a method of determining whether the topic matches the expertise, it may be determined that the expertise does not match the topic when a predetermined number or less of words stored in the expertise column of the user information storage section 231 match the words of the topic of the voice message, and it may be determined that the expertise matches the topic when a predetermined number or more of words match the words of the topic. Another method including considering a semantic distance may be used, or the determination may be performed by using those methods in combination. Then, the extracted user ID of the expert is registered in the destination user ID column of the speech language message storage section 233. When the user ID of the user who issued the voice message is included in the extracted user IDs of experts, the former ID is excluded (S11). When no user ID of a pertinent expert is found or when only the user ID of the user who issued the voice message is found, the user IDs of all the users except the user ID of the user who issued the voice message are stored in the destination user ID column of the speech language message storage section 233 (S12).

Then, it is determined whether any reference information for the input question message is present (S13). When any reference information for the input question message is present, a template of the creation template storage section 235 is referred to and a proxy reply message is created. The message creation section 225 uses a template having a rule name of “reference information presentation” in the creation template storage section 235 to create a proxy reply message to the user as “Reference information to ‘(the voice message input by the user is reproduced)’ is presented. ‘(the voice message registered in the constructed knowledge storage section is reproduced based on the ID stored in the reference information column)’.” Then, the proxy reply message is transmitted from the input/output section 210 of the server 200 to the user terminal 100 and output at the output section 103 of the user terminal 100 (S13). The contents of the created proxy reply message are saved in the speech language message storage section 233, and are paired with the voice message input by the user and saved in the correspondence storage section 232 and the constructed knowledge storage section 234. In addition, reference information search and expert search are performed, and the results are saved in the speech language message storage section 233. Simultaneously, a request for checking the proxy reply message is made to check the validity (described later). Since the message is automatically created in the system, the analysis section 221 does not need to perform analysis thereof.

When no reference information for the input question message is present, the voice message input by the user is transmitted to the user of the user ID stored in the destination user ID of the speech language message storage section 233 (S14). In this case, an answer message from the destination user is waited for. When the reply message is received, that message is transmitted as a reply message to the user who issued the voice message (S15). Simultaneously, its contents are saved in the speech language message storage section 233 in accordance with the flow for voice message registration described above (in FIG. 5) and are paired with the voice message input by the user and saved in the correspondence storage section 232 and the constructed knowledge storage section 234. In addition, reference information search and expert search are performed, and the results are saved in the speech language message storage section 233.

Next, a flow for check request message transmission in the system according to the embodiment is described with reference to FIG. 7. The message creation section 225 refers to the template of the creation template storage section 235 based on the proxy reply message created in the reply message transmission flow and saved in the speech language message storage section 233 to create a check request message (516). A template having a rule name of “check comment request” in the creation template storage section 235 is used to create a check request message as “The following reference information has been presented to ‘(the voice message input by the user is reproduced).’ ‘(the voice message registered in the constructed knowledge storage section 244 is reproduced based on the ID stored in the reference information column)’ If any comment is present, please make a reply.” Then, the check request message is transmitted from the input/output section 210 of the server 200 to the user terminals 100 of the experts and output at the user terminals 100 (S17). The contents of the check request message are saved in the speech language message storage section 233, and are paired with the message from the user and saved in the correspondence storage section 232 and the constructed knowledge storage section 234. Since the message is automatically created in the system, the analysis section 221 does not need to perform analysis thereof.

Thereafter, it is assumed that a complementary message is input from one of the experts who received the check request message (S18). The complementary message is analyzed in the analysis section 221 in accordance with the voice message registration flow described above (in FIG. 5) to determine the speech function and extract the topic. Then, the message is paired with the check request message, saved in the correspondence storage section 232 and the constructed knowledge storage section 234, and saved in the speech language message storage section 233. In addition, reference information search and expert search are performed, and the results are saved in the speech language message storage section 233. Subsequently, a check request message for the complementary message may be created and transmitted to the experts, or a feedback message may be transmitted to any user who has previously asked a question including the same topic based on the contents of the complementary message.

<Description and Specific Examples of Tables>

Next, a procedure for storing information in the storage section 230 and an example of information registration are described with reference to FIG. 8 through FIG. 12. In this example, it is assumed that the system is used by five users having user IDs of U1n, U2n, U3n, U4v, and U5v (hereinafter the users having user IDs of U1n, U2n, U3n, U4v, and U5v are referred to as U1n, U2n, U3n, U4v, and U5v). U1n, U2n, and U3n are beginners who have no expertise in “valves” corresponding to the current topic, whereas U4v and U5v are experts who have expertise in “valves.”

First, FIG. 8 is a diagram showing an example of information registration in the user information storage section 231. The user information storage section 231 includes columns for storing user IDs of users and keywords relating to things in which those users have expertise. The top of the record in FIG. 8 shows the information of the user having the user ID of U1n. The expertise of the user having the user ID of U1n is governors. In this case, “U1n” is registered in the column of “user ID” and “governor” is registered in the column of “expertise.” The user ID is assigned upon registration of the user in the system, and the keyword relating to the thing in which the user has expertise is also registered upon registration of the user.

First, U1n inputs a voice message as “When should valve A be adjusted?” This voice message is transmitted to and analyzed in the analysis section 221 of the server 200. This example assumes that any available knowledge is not present on the system at this point in time. The analysis section 221 identifies the speech function “question” of the voice message and extracts the topic “valve, A, adjust.” The voice message is assigned an ID “m1u” and is saved in the columns of “source user ID,” “message ID,” “message contents,” “speech function,” and “topic” of the speech language message storage section 233. Then, the voice message “m1u” is transmitted to the correspondence extraction section 222. The correspondence extraction section 222 refers to the speech language message storage section 233 to search for any voice message to be paired with the input voice message “m1u.” However, no voice message to be paired with the input voice message “m1u” can be determined, so that an answer is requested of the experts.

Next, expert search is performed. The “expertise” column in the user information storage section 231 is referred to to extract a user ID having expertise matching the topic of the voice message “m1u” saved in the speech language message storage section 233. In this example, U4v and U5v are extracted as experts in the topic “valve, A, adjust.” The extracted user IDs are set as destinations of the voice message “m1u” and are saved in the column of “destination user ID” of the speech language message storage section 233. When the user ID who inputted the voice message is extracted, that user ID is excluded. When no pertinent user is present, the user IDs of all the users except the user ID of the user who inputted the voice message are saved.

Subsequently, the voice message “When should valve A be adjusted?” inputted by U1u is output to the user terminals 100 of the users having the user IDs saved in the “destination user ID” column of the speech language message storage section 233.

It is assumed that, in response thereto, U4v inputs an answer voice message “Valve A should be adjusted after inspection.” The voice message is transmitted to and analyzed in the analysis section 221. The speech function “description” is determined, and the topic “valve, A, adjust, after inspection” is extracted. The voice message is assigned an ID “m2u” and is saved in the columns of “source user ID,” “message ID,” “message contents,” “speech function,” and “topic” of the speech language message storage section 233. Then, the voice message “m2u” is transmitted to the correspondence extraction section 222. The correspondence extraction section 222 refers to the speech language message storage section 233 to search for any voice message to be paired with the input voice message “m2u.” The message to be paired is “m1u.” The correspondence between “m1u” and “m2u” is assigned a pair relationship ID and is saved in the correspondence storage section 232.

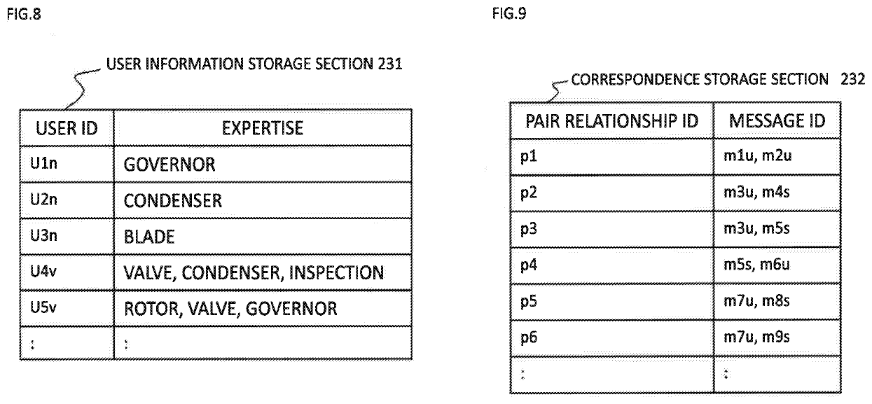

FIG. 9 is a diagram showing an example of information registration in the correspondence storage section 232. The correspondence storage section 232 includes columns for storing pair relationship IDs and paired message IDs of voice messages having correspondences. The top of the record in FIG. 9 shows the correspondence between “m1u” and “m2u” extracted in this example. The assigned pair relationship ID “p1” is stored in the “pair relationship ID” column, and the message IDs “m1u, m2u” of the paired voice messages are stored in the “message ID” column.

Next, the “topic” column of the speech language message storage section 233 is referred to to save the topic “valve, A, adjust” common to the voice messages “m1u” and “m2u” paired in the correspondence extraction section 222 into the constructed knowledge storage section 234. The common topic is assigned a knowledge ID “k1” and is saved in the constructed knowledge storage section 234 together with the associated message IDs.

Since the U1n which inputted the question voice message “m1u” is set as the destination, “U1n” is saved in the “destination user ID” of the speech language message storage section 233. Then, the voice message “m2u” is output as the reply voice message to the user terminal 100 of U1n.

It is assumed that, after some time, U2n inputs a voice message “Adjustment of control valve B is started.” This voice message is transmitted to and analyzed in the analysis section 221. The speech function “description” is determined, and the topic “control, valve, B, adjust, start” is extracted. The voice message is assigned an ID “m3u” and is saved in the columns of “source user ID,” “message ID,” “message contents,” “speech function,” and “topic” of the speech language message storage section 233. Subsequently, the voice message “m3u” is transmitted to the correspondence extraction section 222. The correspondence extraction section 222 refers to the speech language message storage section 233 to search for any voice message to be paired with the input voice message “m3u.” However, no voice message to be paired with the input voice message “m3u” is determined.

Next, the reference information extraction section 223 refers to the “topic” column of the constructed knowledge storage section 234 to identify the knowledge ID “k1” having the topic matching the topic of the voice message “m3u” registered in the speech language message storage section 233. As a result, “k1” is stored in the “reference information” column of the voice message “m3u” in the speech language message storage section 233.

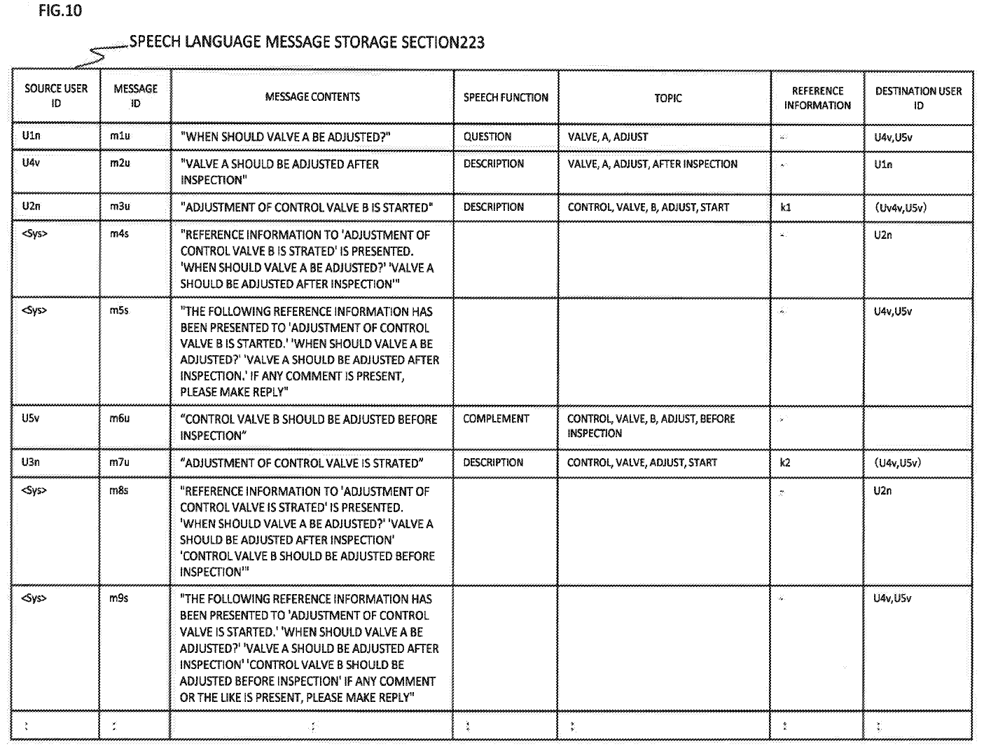

FIG. 10 is a diagram showing an example of information registration in the speech language message storage section 233. The speech language message storage section 233 includes the columns for storing the user IDs of users who issued voice messages, the message IDs assigned to the voice messages, the contents of the voice messages, the speech functions and the topics of the voice messages extracted by the analysis section 221, the reference information referred to from the constructed knowledge storage section 234, and the destination user IDs extracted by the expert determination section 224 and specified as destinations of the voice messages. The contents of the voice message are saved, for example as recorded speech waveform data or text data. However, any form of saving may be used as long as the contents of the voice message can be recognized. For the “reference information” column, the “topic” of the constructed knowledge storage section 234 is referred to, and the “knowledge ID” having the matching topic is saved. Based on information associated with the stored “knowledge ID,” a proxy reply message or the like for the voice message is created. When no knowledge ID having any matching topic is present, “-” is stored in the reference information column.

The third row of the record in FIG. 10 shows the information of the voice message assigned the message ID “m3u.” In the “source user ID” column, the user ID “U2n” of the user who inputted the voice message is saved. In the “message ID” column, the assigned “m3u” is saved. In the “message contents” column, the recorded voice data “Adjustment of control valve B is started” is saved. As the result of the analysis in the analysis section 221, “description” is saved in the “speech function” column, and “control, valve, B, adjust, start” is saved in the “topic” column. The knowledge ID “k1” having the matching topic in the constructed knowledge storage section 234 is saved in the “reference information” column. In the “destination user ID” column, the extracted user IDs of the users are saved from expert search with reference to the “topic” of the speech language message storage section 233 and the “expertise” of the user information storage section 231. While “U4v” and “U5v” are extracted in this case, the voice message is not transmitted due to the presence of reference information. Thus, “(U4v, U5v)” is stored in parentheses. It should be noted that the voice message of the user may be transmitted to the expert even when reference information is present.

In response to the voice message “m3u,” available knowledge is present on the system at this point in time, so that the template of the creation template storage section 235 is referred to to create a proxy reply message. To create such a proxy reply message, the template “t1” having the rule name of “reference information presentation” in the creation template storage section 235 is used, and the “reference information” column of the speech language message storage section 233 is referred to. Then, a proxy reply message is created as “Reference information to ‘Adjustment of control valve B is started (voice message ID: m3u)’ is presented. ‘When should valve A be adjusted? (voice message ID: m1u)’ ‘Valve A should be adjusted after inspection (voice message ID: m2u)’ (knowledge ID: k1).” Since the user having the user ID “U2n” who inputted the voice message “m3u” is set as the destination, “U2n” is saved in the “destination user ID” of the speech language message storage section 233. Then, the created voice message is output as the proxy reply voice message to the user terminal 100 of the user having the user ID “U2n.”

Then, the template of the creation template storage section 235 is further referred to to create a check request message for the proxy message. A template “t2” having the rule name of “check comment request” in the creation template storage section 235 is used, and the “reference information” column of the speech language message storage section 233 is referred to. A check request message is created as “The following reference information has been presented to ‘Adjustment of control valve B is started (voice message ID: m3u).’ ‘When should valve A be adjusted? (voice message ID: m1u)’ ‘Valve A should be adjusted after inspection (voice message ID: m2u)’ (knowledge ID: k1) If any comment is present, please make a reply.” Then, the “expertise” column of the user information storage section 231 is referred to to extract the user ID of the user having “expertise” matching the topic of the voice message “m3u” saved in the speech language message storage section 233. In this example, the users having user IDs “U4v” and “U5v” are extracted, and “U4v, U5v” are saved in the “destination user ID” of the speech language message storage section 233. Then, the created voice message is output as the check request message to the user terminals of U4v, U5v.

The contents of the proxy request message and the check request message are saved in the speech language message storage section 233 with <Sys>, representing the system, assigned as the source user ID, and “m4s” and “m5s” assigned as the message ID. The correspondence storage section 232 pairs each of those messages with the voice message “m3u,” assigns pair relationship IDs “p2” and “p3,” and saves them in the correspondence storage section 232. The topic “valve, adjust” common to the voice messages “m4s,” “m5s” paired with the voice message “m3u” is extracted. The extracted common topic is assigned a knowledge ID “k2” and is saved in the constructed knowledge storage section 234 together with the associated message IDs.

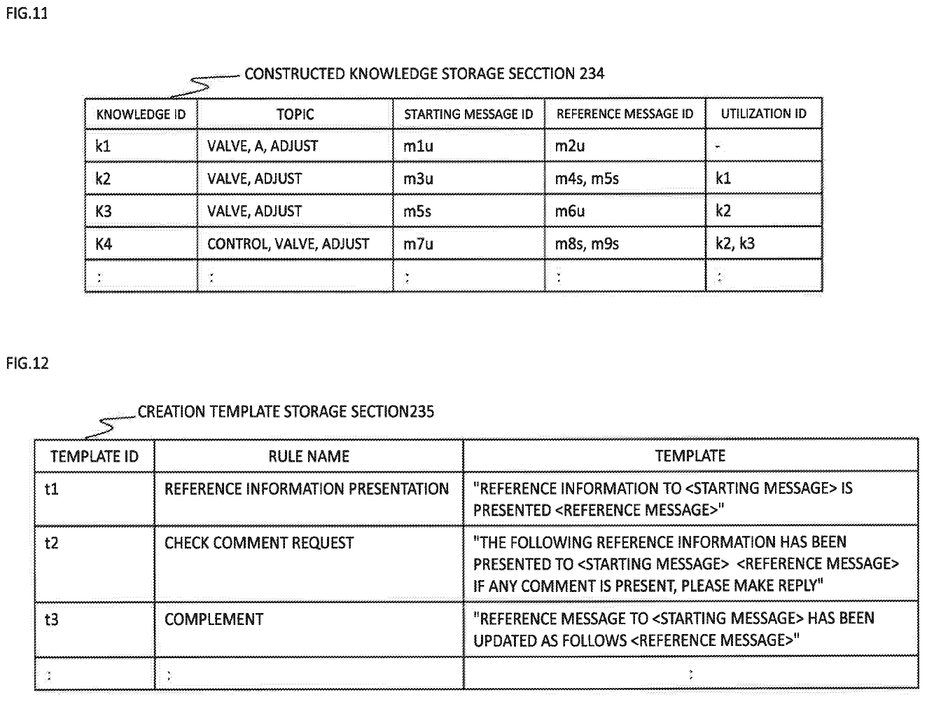

FIG. 11 is a diagram showing an example of information registration in the constructed knowledge storage section 234. The constructed knowledge storage section 234 includes the columns for storing the knowledge IDs, the extracted common topics, the message IDs of starting messages in message pairing, the message IDs of reference messages paired with the starting messages, and utilization knowledge IDs referred to in creating or identifying the reference messages.

The second row of the record in FIG. 11 shows reference knowledge assigned the knowledge ID “k1.” In the “starting message” column, the message ID “m3u” is stored which has the message contents “Adjustment of control valve B is started.” In the “reference message” column, the message IDs “m4s, m5s” of the messages paired with the starting message are stored. Since the knowledge of the knowledge ID “k1” in the constructed knowledge storage section 234 is referred to in creating the reference message, “k1” is stored in the “utilization knowledge ID” column.

It is assumed that, in response to the check request message “m5s” created in the system, u5v inputs a voice message “Control valve B should be adjusted before inspection.” This voice message is transmitted to and analyzed in the analysis section 221. Then, the speech function “complement” is determined, and the topic “valve, B, adjust, before inspection” is extracted. This voice message is assigned an ID “m6u” and is saved in the columns of “source user ID,” “message ID,” “message contents,” “speech function,” and “topic” of the speech language message storage section 233. Then, the voice message “m6u” is transmitted to the correspondence extraction section 222. The correspondence extraction section 222 refers to the speech language message storage section 233 to search for any voice message to be paired with the input output message “m6u.” The message to be paired is “m5s.” The correspondence between “m5s” and “m6u” is assigned a pair relationship ID “p4” and is saved in the correspondence storage section 232.

Subsequently, the “topic” column of the speech language message storage section 233 is referred to to save the topic “valve, adjust” common to the voice messages “m5s” and “m6u” paired in the correspondence extraction section 222 into the constructed knowledge storage section 234. The common topic is assigned a knowledge ID “k3” and is saved in the constructed knowledge storage section 234 together with the associated message IDs.

In this example, when the speech function of the voice message is “complement,” the destination is not set. However, a feedback message may be created and transmitted by specifying, as the destination, the user having the user ID “U2n” who inputted the voice message “m3u” causing the transmission of the proxy reply message “m4s” and the check request message “m5s” or the user having the user ID “U1n” who inputted the voice message “m1u” having the same topic “valve, adjust” and the speech function “question.” In addition, a check request message to the feedback message may be created and transmitted by specifying, as the destination, the user IDs of experts except the user having the user ID “U5v” who inputted the voice message having the speech function “complement.”

It is assumed that, after some time, U3n inputs a voice message “Adjustment of control valve is started.” This voice message is transmitted to and analyzed in the analysis section 221 of the server 200. The analysis section 221 identifies the speech function “description” of the voice message and extracts the topic “control, valve, adjust, start.” The voice message is assigned an ID “m7u” and is saved in the columns of “source user ID,” “message ID,” “message contents,” “speech function,” and “topic” of the speech language message storage section 233. Subsequently, the voice message “m7u” is transmitted to the correspondence extraction section 222. The correspondence extraction section 222 refers to the speech language message storage section 233 to search for any voice message to be paired with the input voice message “m7u.” No voice message to be paired with the voice message “m7u” is extracted.

Next, the reference information extraction section 223 refers to the “topic” column of the constructed knowledge storage section 234 to identify the knowledge ID “k2” most matching the topic of the voice message “m7u” registered in the speech language message storage section 233. As a result, “k2” is stored in the “reference information” column of the voice message “m7u” in the speech language message storage section 233.

In response to the voice message “m7u,” available knowledge is present on the system at this point in time, so that the template of the creation template storage section 235 is referred to to create a proxy reply message.

FIG. 12 is a diagram showing an example of information registration in the creation template storage section 235. The creation template storage section 235 includes the columns for storing the template IDs, the rule names showing the situations in which the associated templates are used, and the template forms. The first row of the record in FIG. 12 shows the information of the template stored in a template ID “t1.” In the “template ID” column, the ID “t1” assigned to the template is previously saved. In the “rule name” column, the situation in which the template is used, “reference information presentation,” is previously saved. In the “template” column, the template form “Reference information to <starting message> is presented <reference message>” is previously saved. To create a message, the voices of the voice message IDs saved in the constructed knowledge storage section 234 can be put into the <starting message> and <reference message>. The type of template may be added or deleted by a user or a system manager.

To create a proxy reply message, the template “t1” of the rule name “reference information presentation” in the creation template storage section 235 is used, and the “reference information” column of the speech language message storage section 233 is referred to. The proxy reply message is created as “Reference information to ‘Adjustment of control valve is started (voice message ID: m7u)” is presented. ‘When should valve A be adjusted? (voice message ID: m1u)’ ‘Valve A should be adjusted after inspection (voice message ID: m2u)’ ‘Control valve B should be adjusted before inspection (voice message ID: m6u)’ (knowledge ID: k2)” Since the user having the user ID “U3n” who inputted the voice message “m7u” is set as the destination, “U3n” is saved in the “destination user ID” of the speech language message storage section 233. Then, the created voice message is output as the proxy reply voice message to the user terminal 100 of the user having the user ID “U3n.”

The template of the creation template storage section 235 is referred to to create a check request message for the proxy message. The template “t2” having the rule name of “check comment request” in the creation template storage section 235 is used, and the “reference information” column in the speech language message storage section is referred to. A check request message is created as “The following reference information has been presented to ‘Adjustment of control valve is started (voice message ID: m7u).’ ‘When should valve A be adjusted? (voice message ID: m1u)’ ‘Valve A should be adjusted after inspection (voice message ID: m2u)’ ‘Control valve B should be adjusted before inspection (voice message ID: m6u)’ (knowledge ID: k2) If any comment is present, please make a reply.” Then, the “expertise” column of the user information storage section 231 is referred to to extract the user ID of the user having “expertise” matching the topic of the voice message “m7u” saved in the speech language message storage section 233. In this example, the users having user IDs “U4v” and “U5v” are extracted, and “U4v, U5v” are saved in the “destination user ID” of the speech language message storage section 233. Then, the created voice message is output as the check request message to the user terminals 100 of the users U4v, U5v.

The contents of the proxy reply message and the check request message are saved in the speech language message storage section 233 with <Sys>, representing the system, assigned as the source user ID, and “m8s” and “m9s” assigned as the message IDs. The correspondence storage section 232 pairs each of those messages with the voice message “m7u,” assigns the pair relationship IDs “p5” and “p6,” and saves them. The topic “valve, adjust” common to the voice message “m8s,” “m9s” paired with the voice message “m7u” is extracted. The extracted common topic is assigned a knowledge ID “k4” and is saved in the constructed knowledge storage section 234 together with the associated message IDs. Thereafter, the similar processing is continued.

As described above, the proxy reply message is created immediately based on the constructed information to maintain the real-time nature of the answer to the question, while the check request message is transmitted to the expert to check the accumulated knowledge, thereby achieving the system capable of more reliable automatic answering.

<Applications>

Next, applications of the above knowledge construction and utilization system are described.

(Contribution Analysis and Useful Knowledge Introduction)

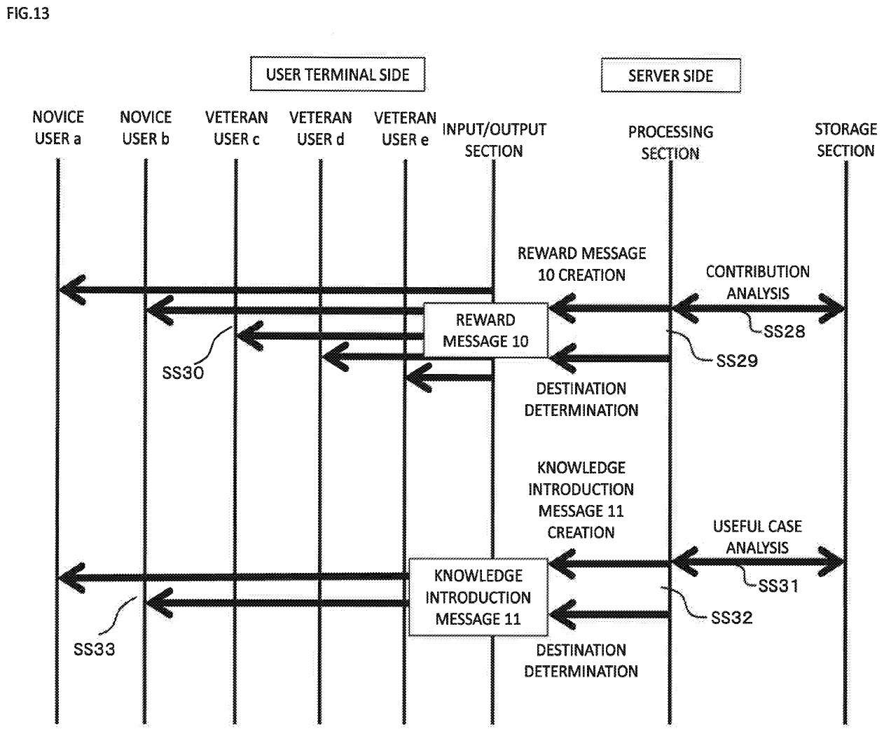

FIG. 13 is a sequence diagram relating to contribution analysis and useful knowledge introduction of the knowledge construction and utilization system according to the embodiment. In this example, the system is used by five users including novice users a, b, and veteran users c, d, and e. The novice users a, b are beginners who do not have expertise in topics being treated in the example, and the veteran users c, d, and e are experts having expertise.

First, the contribution analysis is described. It is assumed that the system has a mechanism in which a contribution analysis section, not shown, assigns points based on the speech function of each voice message determined by the analysis section 221 such that five points are given to a user who inputted a question message, 15 points are given to a user who inputted a complementary message including complementary information in response to an output check request message, and 20 points are given to a user who inputted a correction message including correction information. In accordance with the mechanism, the contribution analysis is performed to determine how many points should be given to which user (SS28). The contribution analysis may be performed periodically or each time a question message is input. In addition, a “point” column may be provided in the user information storage section 231 to save information about given points for each user. Based on the result of the contribution analysis, “reward message 10” for providing the user with information about given points is created, for example by using a template in the creation template storage section 235 (SS29). Then, the reward message 10 is transmitted to each user (SS30). The contribution analysis is performed for the purpose of encouraging the user to use the system by making the user feel that it is worthwhile or allowing the user to use pay services with no charge through the use of given points. The information about given points may be displayed on a user log-in screen in a ranking list instead of transmission as the reword message.

Next, the useful knowledge introduction is described. In this illustrative case, the novice users a, b are beginners who do not have expertise in the topic being treated in the example, and a message for introducing useful knowledge about the topic is transmitted to the novice users a, b. First, a useful case analysis section, not shown, refers to the speech language message storage section 233 to perform useful case analysis by searching for any voice message having a topic stored in the topic column which at least partially matches the topic being treated in the example (SS31). The frequency of reference of the knowledge ID stored in the reference information column may also be considered. Next, the constructed knowledge storage section 234 is referred to from the knowledge ID stored in the reference information column, and based on the associated saved voice message, the template in the creation template storage section 235 is used to create a “knowledge introduction message 11” for presenting useful knowledge to the novice users a, b (SS32). Then, the reference knowledge message 11 is transmitted to the novice users a, b specified as the destination (SS33). It is presented to the beginner users. For the timing of the useful knowledge introduction, the useful information may be displayed in text form during the waiting time at the system start-up, or may be presented when the user inputs a voice message or text as “Please present useful knowledge” to make access. This function can determine the knowledge which the beginners should have, so that the operation can be performed more smoothly.

(To Provide Urgency for Voice Message)

The urgency of an input voice message may be estimated, and a voice message created from that voice message may be output with urgency. For example, during registration of a user, the voice frequency and the speech rate of usual conversation of the user are analyzed and registered as standard values in “basic frequency F₀” and “basic mora/sec” columns provided in the user information storage section 231. Thereafter, when the user inputs an answer message to a voice message, the analysis section 221 of the server 200 analyzes the answer message with reference to the “basic frequency F₀” and “basic mora/sec” columns of the user information storage section 231. It is assumed that a threshold value is set at 5%. When the voice frequency or the speech rate of the input answer message are higher than the values stored in the user information storage section 231 by 5% or more, it is determined that “urgency is present,” and a creation template for urgency can be used to create a reply message and output the reply message with an alarm sound. In addition, the reply message can be output at an increased volume or can be output in preference to other messages. Furthermore, the answer message and the created reply message are given flags showing urgency and are saved in the speech language message storage section 233. The threshold value may be determined arbitrarily by the user or the system manager. Instead of registering the voice frequency or the speech rate of conversation for each user during the user registration, the average values based on the age and sex may be used as standard values. This function can provide correct knowledge immediately to prevent mistakes even when an inappropriate voice message is output.

The technique described in the above embodiment can be stored and distributed as a program executable by computers in storage media including magnetic disks (including hard disks), optical disks (including CD-ROMs and DVDs), magneto-optical (MO) disks, and semiconductor memories. Such a storage medium may have any storage form as long as it can store the program and can be read by computers. The program may be installed from the storage medium to a computer and may instruct the OS (Operating System) running on the computer or MW (Middleware) such as database management software and network software to perform part of the processing for implementing the embodiment. The storage medium in the embodiment is not limited to a medium independent of the computer but includes a storage medium which stores or temporarily stores a downloaded program transmitted over the LAN or the Internet. The storage medium is not limited to a single medium and includes the case when the processing in the embodiment is performed from a plurality of media, and any medium configuration may be used.

The computer in the embodiment refers to any apparatus performing the processing in the embodiment based on the program stored in the storage medium, and may be configured as a single apparatus such as a personal computer or as a system including a plurality of networked apparatuses. Each of the storage apparatuses in the embodiment may be implemented by a single storage apparatus or by a plurality of storage apparatuses. The computer in the embodiment includes not only a personal computer but also an arithmetic processing unit included in an information processing device or a microcomputer (microprocessor), and generally refers to devices and apparatuses capable of performing the functions of the embodiment based on the program.

While the embodiment of the present invention has been described, the embodiment is only illustrative and is not intended to limit the scope of the present invention. The novel embodiment can be implemented in various other forms, and various omissions, substitutions, and modifications can be made thereto without departing from the spirit or scope of the present invention. The embodiment and its variations are encompassed within the spirit or scope of the present invention and within the invention set forth in the claims and the equivalents thereof.

### DESCRIPTION OF THE REFERENCE NUMERALS

100 USER TERMINAL
101 INPUT SECTION
102 COMMUNICATION SECTION
103 OUTPUT SECTION
200 SERVER
210 INPUT/OUTPUT SECTION
220 PROCESSING SECTION
221 ANALYSIS SECTION
222 CORRESPONDENCE EXTRACTION SECTION
223 REFERENCE INFORMATION EXTRACTION SECTION
224 EXPERT DETERMINATION SECTION
225 MESSAGE CREATION SECTION
230 STORAGE SECTION
231 USER INFORMATION STORAGE SECTION
232 CORRESPONDENCE STORAGE SECTION
233 SPEECH LANGUAGE MESSAGE STORAGE SECTION
234 CONSTRUCTED KNOWLEDGE STORAGE SECTION
235 CREATION TEMPLATE STORAGE SECTION
300 NETWORK

1: A knowledge construction and utilization system comprising a plurality of user terminals and a server,
wherein each of the user terminals includes:
input means for inputting a first knowledge information piece;
communication means for transmitting and receiving the first knowledge information piece to and from the server; and
output means for outputting a knowledge information piece received from the server, and
the server includes:
reception means for receiving the first knowledge information piece input from one of the user terminals;
analysis means for analyzing a topic and a speech function of the first knowledge information piece;
storage means for saving knowledge information pieces and a correspondence between the knowledge information pieces;
correspondence extraction means for extracting one or more of the knowledge information pieces having a correspondence to the first knowledge information piece from the storage means based on the result in the analysis means;
transmission means for transmitting the extracted one or more knowledge information pieces to the one of the user terminal; and
notification means for notifying the other user terminals than the user terminal which transmitted the first knowledge information piece of the fact that the one or more knowledge information pieces are transmitted to the user terminal.

2: The knowledge construction and utilization system according to claim 1, wherein the storage means further saves user identification information and user expertise associated with each other,
the server further includes expert determination means for referring to the user expertise from the storage means to determine a destination of the notification based on the topic of the first knowledge information piece, and
the notification means transmits the notification to at least one of the user terminals corresponding to the destination determined by the expert determination means.

3: The knowledge construction and utilization system according to claim 1, wherein the content of the notification is a knowledge information piece including at least the extracted one or more knowledge information pieces.

4: The knowledge construction and utilization system according to claim 1, wherein, when no knowledge information piece having a correspondence to the first knowledge information piece is present in the correspondence extraction means, the content of the notification is the first knowledge information piece, and the content of the notification is transmitted to the destination determined by the expert determination means to ask for a reply.

5: The knowledge construction and utilization system according to claim 4, wherein the analysis means analyzes a topic and a speech function of a second knowledge information piece input as a reply to the content of the notification from one of the other terminals,
the storage section further saves a correspondence between the first knowledge information piece and the second knowledge information piece, and
the transmission means transmits the extracted second knowledge information piece to the user terminal which transmitted the first knowledge information piece.

6: The knowledge construction and utilization system according to claim 3, wherein the notification means notifies the other user terminals of the content of the knowledge information piece notified to the user terminal which transmitted the first knowledge information piece to make a check request to the other user terminals.

7: The knowledge construction and utilization system according to claim 1, wherein the server further includes contribution analysis means for giving a contribution of a knowledge information piece based on the analysis result in the analysis means, and
the notification means notifies the contribution to the user terminal which transmitted the knowledge information piece.

8: The knowledge construction and utilization system according to claim 1, wherein the knowledge information piece is a voice information piece.

9: The knowledge construction and utilization system according to claim 8, wherein, when a voice information piece is input in response to the check request from the notification means,
the analysis means analyzes a voice frequency and a speech rate of the voice information piece, and
the notification means notifies the voice information piece in a different manner when the voice frequency or the speech rate is outside a range of predetermined values.

10: A server connected to a plurality of user terminals and a storage section for storing knowledge information pieces and included in a knowledge construction and utilization system, the server comprising:
reception means for receiving a first knowledge information piece input from one of the user terminals;
analysis means for analyzing a topic and a speech function of the first knowledge information piece;
correspondence extraction means for extracting one or more of the stored knowledge information pieces having a correspondence to the first knowledge information piece based on the result of the analysis;
transmission means for transmitting the extracted one or more knowledge information pieces to the one of the user terminals; and
notification means for notifying the other user terminals than the user terminal which transmitted the first knowledge information piece of the fact that the one or more knowledge information pieces are transmitted to the user terminal.

11: A knowledge construction and utilization program executable by a server connected to a plurality of user terminals and a storage section for storing knowledge information pieces and included in a knowledge construction and utilization system, the program causing the server to perform:
a reception function of receiving a first knowledge information piece input from one of the user terminals;
an analysis function of analyzing a topic and a speech function of the first knowledge information piece;
a correspondence extraction function of extracting one or more of the stored knowledge information pieces having a correspondence to the first knowledge information piece based on the result of the analysis;
a transmission function of transmitting the extracted one or more knowledge information pieces to the one of the user terminals; and
a notification function of notifying the other user terminals than the user terminal which transmitted the first knowledge information piece of the fact that the one or more knowledge information pieces are transmitted to the user terminal.
